(19) United States
(12) Patent Application Publication
(10) Pub. No.: US 2013/0255970 A1
(43) Pub. Date: Oct. 3, 2013

(54) Fluid Delivery System

(71) Applicant: LEEMARK FIRE PROTECTION PTY LTD, Mitcham (AU)

(72) Inventor: Leigh Francis Sullivan, Donvale (AU)

(73) Assignee: Leemark Fire Protection Pty Ltd, Mitcham (AU)

(21) Appl. No.: 13/664,006

(22) Filed: Oct. 30, 2012

(30) Foreign Application Priority Data
Mar. 27, 2012 (AU) 2012901215
May 16, 2012 (AU) 2012901999

(51) Int. Cl. A62C 37/00

(52) U.S. Cl. 169/13

(57) ABSTRACT

A fluid delivery system for delivering fluid in response to fire. The system includes one or more fluid delivery devices responsive to fire to deliver fluid, an inlet pipe for conveying fluid toward the fluid delivery devices, and one or more flow sensors. At least one of the flow sensors is arranged to sense when fluid is flowing along the inlet pipe towards the devices, a pump and plumbing. The plumbing connects the pump in parallel to the flow sensor of the inlet pipe to pressurize portions of the system downstream of the flow sensor of the inlet pipe. The plumbing also connects a portion downstream of at least one of the flow sensors to an upstream side of the pump to define a fluid circuit about which fluid may be circulated by the pump to test the at least one of the flow sensors of the system.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to fluid delivery systems, responsive to fire, and to components therefor.

### BACKGROUND

Some buildings are equipped with a fluid delivery system to combat the outbreak of fire. Such fluid delivery systems may deliver a fire suppressant such as water, foam or gas. Such delivery systems aim to extinguish the fire, or at least to suppress the fire to facilitate the safe escape of building occupants and to extend the time for firefighters to arrive.

Such fluid delivery systems include a network of pipes for conveying the fluid from a fluid source (e.g. mains water supply) to appropriate locations within the building and can be broadly divided into two categories: wet and dry systems.

In dry systems, the pipe networks are typically empty during normal operation and only filled with water in response to an alarm signal, e.g. an alarm signal from a smoke detector or from a manually operated alarm button. Wet systems are fully filled with fluid in normal operation.

In an existing form of wet system, the pipe network is fully filled with water and has spaced along its lengths water delivery devices in the form of sprinkler heads. Each sprinkler head includes a valve element which is held in its blocking position by a liquid-filled glass capsule. The capsules are configured such that the heat of fire causes the contained liquid to expand and break the glass so as to allow the valve element to move from its blocking position. The sprinkler head is thus activated to deliver water.

The flow of water towards the sprinkler head can be used to provide an indication of the presence of fire. As such, various existing wet systems include an “alarm valve” upstream of their sprinkler heads. The alarm valve constitutes both a check valve and a flow sensor. A signal from the alarm valve indicating flow therethrough is thus an alarm signal indicative of fire in the building. This alarm signal may be used to trigger an audible alarm and/or to automatically contact emergency services.

To prevent false alarms, some existing wet systems are provided with a “jacking pump”. The jacking pump is arranged in parallel to the alarm valve and is responsive to a pressure sensor arranged to detect the fluid pressure in the system downstream of the alarm valve. The jacking pump cycles on and off (typically being on less than once an hour) to hold the fluid pressure downstream of the alarm valve above that of upstream pressures so that flow through the alarm valve which would otherwise trigger a false alarm is prevented. Flow through the jacking pump is restricted, e.g. by an orifice plate, so that flow through the sprinkler heads due to a fire is not masked by the jacking pump.

Typically the sprinklers are grouped into separate zones. By way of example, there may be a respective zone for each floor of a multi-storey building. The sprinklers of each group or zone are, in various existing systems, associated with a respective branch pipe branching from a common inlet pipe along which the alarm valve is mounted. Various existing systems include, along each branch pipe, a respective flow sensor or “flow switch” upstream of the sprinklers. These additional flow switches provide signals which allow the specific zone in which there is a fire to be identified. By way of example, the signal from the flow switches may be routed to a common control and indicating equipment (CIE, also known as a fire indicator panel—FIP) which provides a clear indication to firefighters so they can immediately proceed to the appropriate level of the building.

From time to time the flow sensors should be tested to ensure that they remain operational. The present inventor has recognised that existing approaches to testing these flow sensors are messy, labor intensive and wasteful.

An existing approach to testing the flow sensors involves a first person manually sequentially opening and closing respective valves of each branch pipe to dump water to a waste stream whilst the second person observes the CIE.

It is not admitted that any of the information in this patent specification is common general knowledge, or that the person skilled in the art could be reasonably expected to ascertain or understand it, regard it as relevant or combine it in any way at the priority date.

### SUMMARY

One aspect of the present disclosure provides a fluid delivery system, for delivering fluid in response to fire, including

one or more fluid delivery devices responsive to fire to deliver fluid;

an inlet conduit for conveying fluid toward the fluid delivery devices;

one or more flow sensors, including a flow sensor arranged to sense when fluid is flowing along the inlet conduit towards the devices;

a pump; and

plumbing to
connect the pump in parallel to the flow sensor of the inlet conduit to pressurise portions of the system downstream of the flow sensor of the inlet conduit; and
connect a portion downstream of at least one of the flow sensors to an upstream side of the pump to define a fluid circuit about which fluid may be circulated by the pump to test the at least one of the flow sensors.

Preferably the plumbing is configured or configurable to connect a downstream side of the pump to an upstream side of the flow sensor of the inlet conduit to include the flow sensor of the inlet conduit in the fluid circuit to test the flow sensor of the inlet conduit.

The system may include one or more branch conduits, wherein

each branch conduit connects the inlet conduit to at least one of the fluid delivery devices and includes at least one of the flow sensors to sense when fluid is flowing along the branch conduit toward its fluid delivery device(s); and

the plumbing is configured or configurable to connect a portion of each branch conduit downstream of its flow sensor to an upstream side of the pump to include the flow sensor of the branch conduit in the fluid circuit to test the flow sensor of the branch conduit.

Another aspect of the present disclosure provides a fluid delivery system, for delivering fluid in response to fire, including

one or more fluid delivery devices responsive to fire to deliver fluid;

an inlet conduit for conveying fluid toward the fluid delivery devices;

one or more flow sensors;

a pump;

one or more branch conduits; and

plumbing

wherein
the plumbing is configured or configurable to connect a portion downstream of at least one of the flow sensors to an upstream side of the pump to define a fluid circuit about which fluid may be circulated by the pump to test the at least one of the flow sensors of the system;
at least one of the flow sensors is configured to sense when fluid is flowing along the inlet conduit towards the devices;
the plumbing is configured or configurable to connect a downstream side of the pump to an upstream side of the flow sensor of the inlet conduit to include the flow sensor of the inlet conduit in the fluid circuit to test the flow sensor of the inlet conduit;
each branch conduit connects the inlet conduit to at least one of the fluid delivery devices and includes at least one of the flow sensors to sense when fluid is flowing along the branch conduit toward its fluid delivery device(s); and
the plumbing is configured or configurable to connect a portion of each branch conduit downstream of its flow sensor to an upstream side of the pump to include the flow sensor of the branch conduit in the fluid circuit to test the flow sensor of the branch conduit.

The system may include two or more of the branch conduits and one or more valves operable to selectively include a respective one of the branch conduits in the fluid circuit to test the flow sensor of the respective one of the branch conduits separately from the flow sensors of the other branch conduits. Preferably a respective one of the operable valves is associated with each branch conduit and positioned between the flow sensor of its branch conduit and a common return conduit for connecting the upstream side of the pump to each branch conduit.

Preferably the plumbing is configured or configurable to connect a downstream side of the flow sensor of the inlet conduit to an upstream side of the pump to bypass the branch conduits.

The fluid delivery devices may be sprinklers. Preferably the system further includes a user interface mounted or mountable in proximity to a CIE and by which a user may control valves of the plumbing.

Another aspect of the present disclosure provides a pump unit for a fluid delivery system responsive to fire, the unit including

a pump; and

an inlet and an outlet by which the pump is connected or connectable in parallel to a flow sensor of the system to pressurise portions of the system downstream of the flow sensor;

wherein the unit is configured to reverse its direction of flow to test the flow sensor.

The pump may be uni-directional and the unit may include plumbing configured to

selectively respectively connect an upstream side of the pump to each of the inlet and the outlet; and

selectively respectively connect a downstream side of the pump to each of the inlet and the outlet.

The unit preferably includes a further inlet for receiving fluid from one or more branch conduits of the system. Optionally the unit further includes a data outlet and a controller for generating and sending via the data outlet control signals to one or more valves of the system to control flow to the further inlet.

Another aspect of the present disclosure provides a pump unit for a fluid delivery system responsive to fire, the unit including

a pump;

an inlet and an outlet by which the unit is connected or connectable to the system to drive fluid through a flow sensor of the system to test the flow sensor;

a data outlet; and

a controller for generating and sending via the data outlet control signals to one or more valves of the system to control flow to the inlet.

Preferably the controller is configured to selectively control valves of branch conduits of the system to separately test the flow sensor of each of the branch conduits.

The unit may include a casing housing its pump and plumbing. Preferably the unit includes a user interface mounted or mountable in proximity to a CIE and by which a user may control valves of the plumbing.

### BRIEF DESCRIPTION OF THE DRAWINGS

FIG. 1 schematically illustrates an exemplary fluid delivery system.

### DETAILED DESCRIPTION OF THE DRAWINGS

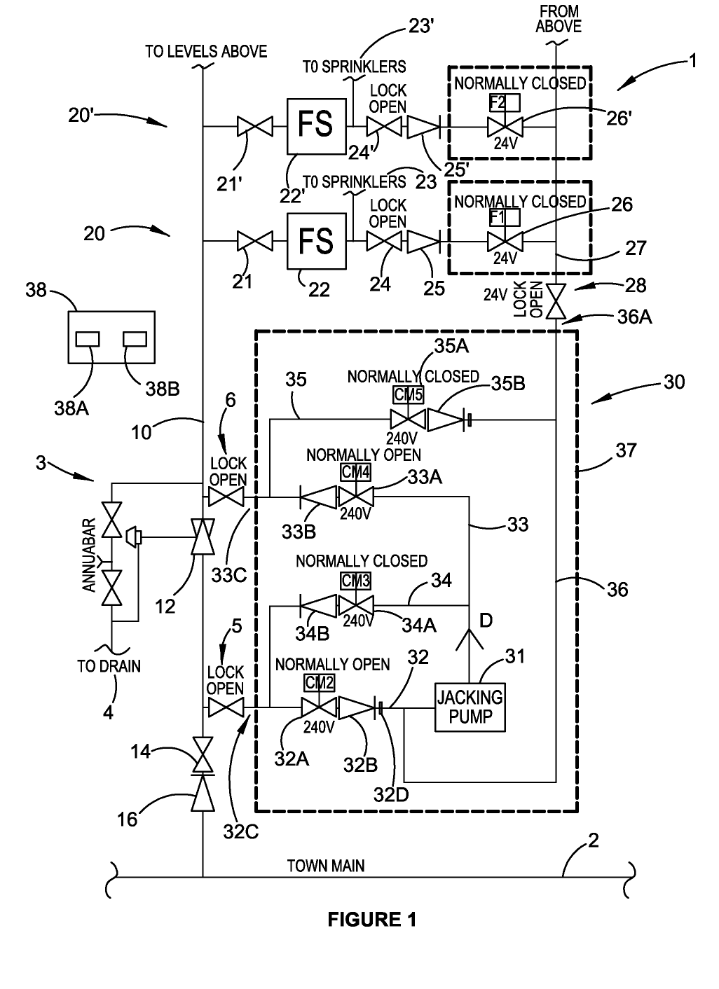

FIG. 1 illustrates a fluid delivery system 1 which is configured to draw water from a town's mains supply 2 and includes plumbing 3 by which the system 1 may be purged to a drain 4 for maintenance.

An inlet pipe 10 conveys water from the mains supply 2 towards branches 20, 20′. An alarm valve 12 is positioned along the inlet pipe 10 and constitutes both a flow sensor and a check valve. Upstream of the alarm valve 12 are controllable valve 14 and check valve 16. The controllable valve 14 allows the system 1 to be selectively isolated from the mains supply 2 for maintenance. The check valve 16 serves to prevent flow of water from the system 1 toward the mains supply 2.

Each branch pipe 20, 20′ is configured to deliver fluid to a respective floor of a multi-storey building. The branch pipe 20 includes a controllable valve 21 fluidly adjacent the inlet pipe 10 for isolating portions of the branch pipe 20 downstream of the valve 21 from the inlet pipe 10 for maintenance. Downstream of the valve 21 is a flow sensor 22. Downstream from the flow sensor 22 are sprinklers 23. The flow sensor 22 provides an indication of fluid flow along the branch pipe 20 towards the sprinklers 23. Each of the sprinklers 23 is of the aforedescribed type including a liquid-filled capsule and is thus responsive to fire to deliver water. The flow sensor 22 thus provides an indication of fire in the zone associated with branch pipe 20.

The branch pipe 20 further includes a line connected to a line connecting the flow sensor 22 and the sprinklers 23. For this purpose the branch pipe 22 may include a T piece or a Y piece fitting. This additional line includes a controllable valve 24, followed by a check valve 25, which is in turn followed by a controllable valve 26. Downstream of the valve 26, the line connects to a common return pipe segment 27.

In system 1 a further branch pipe 20′ is positioned on an upwardly adjacent floor of the building and has a like set of components to the branch pipe 20. Each of the branches 20, 20′ is connected to the common return pipe segment 27.

The system 1 further includes a pump unit 30. The pump unit 30 includes a pump 31, and plumbing including pipes 32, 33, 34, 35 and 36. The pump 31 and plumbing 32 to 36 are housed within a common casing 37.

The pipe 32 connects an upstream side of the pump 31 to the upstream side of the alarm valve 12 via a controllable valve 5. The opening of the pipe 32 from the casing 37 constitutes an inlet 32C and is preferably provided with a threaded connector. The pipe 32 carries a controllable valve 32A and a check valve 32B. The check valve 32B is arranged to allow flow only towards the pump 31.

The pipe 33 connects the pump outlet to the downstream side of the alarm valve 12 via a controllable valve 6 and such that the pump 31, and in turn the pump unit 30, is arranged in parallel to the alarm valve 12. The pump 31 serves to pressurise portions of the system 1 downstream of the alarm valve 12 to prevent water travelling through the alarm valve 12 so as to give a false alarm. The pump 31 thus constitutes a jacking pump. The opening of the pipe 33 from the casing 37 constitutes an inlet 33C and is preferably provided with a threaded connector.

The pump unit 30 further includes a restrictor in the form of an orifice plate 32D along the pipe 32 which serves to limit flow through the jacking pump so the jacking pump does not prevent an alarm signal sounding when one of the sprinklers 23 is opened.

A controllable valve 33A and a check valve 33B are mounted along the pipe 33. The check valve 33B serves to allow flow only towards the inlet pipe 10.

The pipe 34 serves to connect the downstream side of the pump 31 to the upstream side of the alarm valve 12 by branching off the pipe 33 upstream of the valve 33A and connecting to the pipe 32 between the controllable valve 32A and the outlet 32C. A controllable valve 34A and a check valve 34B are arranged along the pipe 34. The check valve 34B serves to allow flow only towards the upstream side of the alarm valve 12.

Pipes 35, 36 together serve to connect the downstream side of the alarm valve 12 to the upstream side of the pump 31. The pipe 35 branches off the pipe 33 between the check valve 33B and the outlet 33C and connects to pipe 36. A controllable valve 35A and a check valve 35B are mounted along the pipe 35. The check valve 35B serves to allow flow only towards the pipe 36.

The pipe 36 opens from the casing 37 at an inlet 36A and connects to the upstream side of the pump 31 by connecting to the pipe 32 between the restrictor 32D and the pump 31.

The pipe 36 is connected to the common return pipe segment 27 via a valve 28 and thus constitutes a further common return pipe segment. The segments 27, 36 together constitute a common return pipe for connecting each of the branches 20, 20′ to an upstream side of the pump 31.

Three operating modes of the system 1 will now be described. The valve positions in each of these operating modes are described in the following table.

| | Normal | Test | Test Alarm |
|---|---|---|---|
| Valve | Position | Sensors 22 | Valve 12 |
| 32A | Open | Closed | Closed |
| 34A | Closed | Closed | Open |
| 33A | Open | Open | Closed |
| 35A | Closed | Closed | Open |
| 26 | Closed | Open/Closed | Closed |
| 26′ | Closed | Open/Closed | Closed |

In the normal operating mode the valves 32A, 33A are opened, whilst the valves 34A, 35A, 26 and 26′ remain closed. In this mode the pump 31 functions in a manner analogous to a conventional jacking pump serving to pressurise portions of the system 1 downstream of the valve 12 in response to a pressure sensor to prevent false alarms.

To test the flow sensors 22, from the normal operating mode, the valve 32A is closed to isolate the pump 31 from the upstream side of the alarm valve 12. The valve 26 is then opened to connect a portion of the branch pipe 20 downstream of the flow sensor 22 to the upstream side of the pump 31. A fluid circuit is thus defined. Fluid is:
pumped from the pump 31,
along the pipe 33,
along portions of the inlet pipe 10 downstream of the alarm valve 12,
along the portion of branch pipe 20 carrying the valve 21 and flow sensor 22,
along the line of branch pipe 20 carrying the valves 24, 25 and 26, and
returned to the pump 31 via the common return pipe 27, 36.

The transition between operating modes in this exemplary system 1 is controlled by a controller 38 of the pump unit 30. For this purpose each of the valves 32A, 33A, 34A, 35A, 26 and 26′ are solenoid valves and the controller 38 includes a data outlet 38A for communicating with these valves. The data outlet 38A may include conductors for directly connecting to the valve 32A, 33A, 34A, 35A internal to the casing 37, and an antenna for wirelessly transmitting signals to the valves 26, 26′. The controller 38 desirably includes logic arrangements for prohibiting transition from the normal operating mode to a testing mode when the alarm valve 12 is signaling an alarm. To transition from testing valve 22 to testing the flow sensor 22′, the valve 26 is closed and the valve 26′ opened. In doing so the branch pipe 20′ is included in the fluid circuit and the branch pipe 20 is excluded.

In a third operating mode the valves are configured to test the alarm valve 12. To transition from the normal operating mode to the alarm valve testing mode the valves 32A, 33 are closed and the valves 34A, 35A are opened. Via this mechanism the pump 31 can be a conventional uni-directional pump (e.g. a centrifugal pump) and the direction of flow through the inlet 32C and the outlet 33C of the pump unit 30 can be reversed. In this alarm valve testing mode, a fluid circuit is defined in which water is:
pumped by the pump 31,
along a short segment of the pipe 33,
along the pipe 34,
along a short segment of the pipe 32,
along a segment of the pipe 10 including the alarm valve 12,
along a short segment of the pipe 33,
along the pipe 35, and
is returned to the pump 31 via the pipe 36.

The pipe 35 serves to bypass the branch pipes 20, 20′.

Many variants to the described exemplary system 1 are possible. By way of example, the valves 5, 6 may be incorporated into the pump unit 30 as may be the valves 26, 26′. The valves 5, 6, 14, 21, 21′, 24, 24′ and 28 are preferably manually operated.

The controller 38 is optionally mounted internal or external to the casing 37 and preferably includes or cooperates with a control panel 38B mounted or mountable adjacent the CIE so that a single operator can conveniently control the system 1 from the control panel and observe the CIE to test the flow sensors 22, 22′ and/or the alarm valve 12. The control panel 38B constitutes a user interface by which a user may control the controllable valves of the system 1. The control panel 38B might, in some variants of the system 1, be integrated with the CIE.

Whilst three distinct operating modes have been described, it is also contemplated that the valves could be controlled to simultaneously test the alarm valve 12 and one or more of the sensors 22, 22′.

For the avoidance of doubt, “pipe” and “conduit” as used herein refer to flowpath defining structure. Of course whilst each pipe may well have a concentric cylindrical interior and exterior this is inessential. By way of example the pipes of the pump unit 30 may be bores within a common mass of material.

An exemplary embodiment of the present disclosure provides improvements in and for fluid delivery systems responsive to fire, or at least to provide an alternative in the marketplace.

Although the present disclosure has been described with reference to one or more examples, workers skilled in the art will recognize that changes may be made in form and detail without departing from the scope of the disclosure and/or the appended claims.

What is claimed is:

1. A fluid delivery system, for delivering fluid in response to fire, comprising:
one or more fluid delivery devices responsive to fire to deliver fluid;
an inlet conduit for conveying fluid toward the fluid delivery devices;
one or more flow sensors, including a flow sensor arranged to sense when fluid is flowing along the inlet conduit towards the devices;
a pump; and
plumbing arranged to:
connect the pump in parallel to the flow sensor of the inlet conduit to pressurize portions of the system downstream of the flow sensor of the inlet conduit; and
connect a portion downstream of at least one of the flow sensors to an upstream side of the pump to define a fluid circuit about which fluid may be circulated by the pump to test the at least one of the flow sensors.

2. The system of claim 1 wherein the plumbing is configured or configurable to connect a downstream side of the pump to an upstream side of the flow sensor of the inlet conduit to include the flow sensor of the inlet conduit in the fluid circuit to test the flow sensor of the inlet conduit.

3. The system of claim 1 including one or more branch conduits, wherein:
each branch conduit connects the inlet conduit to at least one of the fluid delivery devices and includes at least one of the flow sensors to sense when fluid is flowing along the branch conduit toward its fluid delivery device(s); and
the plumbing is configured or configurable to connect a portion of each branch conduit downstream of its flow sensor to an upstream side of the pump to include the flow sensor of the branch conduit in the fluid circuit to test the flow sensor of the branch conduit.

4. The system of claim 3 including two or more of the branch conduits and one or more valves operable to selectively include a respective one of the branch conduits in the fluid circuit to test the flow sensor of the respective one of the branch conduits separately from the flow sensors of the other branch conduits.

5. The system of claim 4 wherein a respective one of the operable valves is associated with each branch conduit and positioned between the flow sensor of its branch conduit and a common return conduit for connecting the upstream side of the pump to each branch conduit.

6. The system of claim 3 wherein the plumbing is configured or configurable to connect a downstream side of the flow sensor of the inlet conduit to an upstream side of the pump to bypass the branch conduits.

7. The system of claim 1 wherein the fluid delivery devices are sprinklers.

8. The system of claim 1 further including a user interface mounted or mountable in proximity to a common control and indicating equipment (CIE) and by which a user may control valves of the plumbing.

9. A fluid delivery system, for delivering fluid in response to fire, comprising:
one or more fluid delivery devices responsive to fire to deliver fluid;
an inlet conduit for conveying fluid toward the fluid delivery devices;
one or more flow sensors;
a pump;
one or more branch conduits; and
plumbing,
wherein:
the plumbing is configured or configurable to connect a portion downstream of at least one of the flow sensors to an upstream side of the pump to define a fluid circuit about which fluid may be circulated by the pump to test the at least one of the flow sensors of the system;
at least one of the flow sensors is configured to sense when fluid is flowing along the inlet conduit towards the devices;
the plumbing is configured or configurable to connect a downstream side of the pump to an upstream side of the flow sensor of the inlet conduit to include the flow sensor of the inlet conduit in the fluid circuit to test the flow sensor of the inlet conduit;
each branch conduit connects the inlet conduit to at least one of the fluid delivery devices and includes at least one of the flow sensors to sense when fluid is flowing along the branch conduit toward its fluid delivery device(s); and
the plumbing is configured or configurable to connect a portion of each branch conduit downstream of its flow sensor to an upstream side of the pump to include the flow sensor of the branch conduit in the fluid circuit to test the flow sensor of the branch conduit.

10. The system of claim 9 including two or more of the branch conduits and one or more valves operable to selectively include a respective one of the branch conduits in the fluid circuit to test the flow sensor of the respective one of the branch conduits separately from the flow sensors of the other branch conduits.

11. The system of claim 10 wherein a respective one of the operable valves is associated with each branch conduit and positioned between the flow sensor of its branch conduit and a common return conduit for connecting the upstream side of the pump to each branch conduit.

12. The system of claim 9 wherein the plumbing is configured or configurable to connect a downstream side of the flow sensor of the inlet conduit to an upstream side of the pump to bypass the branch conduits.

13. The system of claim 9 wherein the fluid delivery devices are sprinklers.

14. The system of claim 9 further including a user interface mounted or mountable in proximity to a common control and indicating equipment (CIE) and by which a user may control valves of the plumbing.

15. A pump unit for a fluid delivery system responsive to fire, the unit comprising:
a uni-directional pump;
an inlet and an outlet by which the unit is connected or connectable in parallel to a flow sensor of the system to pressurize portions of the system downstream of the flow sensor; and
plumbing configured to:
selectively respectively connect an upstream side of the pump to each of the inlet and the outlet; and
selectively respectively connect a downstream side of the pump to each of the inlet and the outlet,
whereby the unit is configured to reverse its direction of flow to test a flow sensor of the system.

16. The unit of claim 15 including a further inlet for receiving fluid from one or more branch conduits of the system.

17. The unit of claim 16 further including a data outlet and a controller configured to generate and send sending via the data outlet control signals to one or more valves of the system to control flow to the further inlet.

18. The unit of claim 15 including a casing housing its pump and plumbing.

19. The unit of claim 15 further including a user interface mounted or mountable in proximity to a common control and indicating equipment (CIE) and by which a user may control valves of the plumbing.

20. A pump unit for a fluid delivery system, the system being responsive to fire and including branch conduits, each branch conduit respectively including a valve and a flow sensor, the unit comprising:
a pump;
an inlet and an outlet by which the unit is connected or connectable to the system to drive fluid through the flow sensors of the system to test the flow sensors;
a data outlet; and
a controller configured to generate and send via the data outlet control signals to the valves to separately test each of the branch conduits.

21. The unit of claim 20 including a casing housing its pump and plumbing.

22. The unit of claim 20 further including a user interface mounted or mountable in proximity to a common control and indicating equipment (CIE) and by which a user may control valves of the plumbing.
